(19) United States
(12) Patent Application Publication
(10) Pub. No.: US 2017/0165949 A1
(43) Pub. Date: Jun. 15, 2017

(54) HEAT SHIELDING MATERIAL, HEAT SHIELDING COMPOSITION AND HEAT SHIELDING STRUCTURE EMPLOYING THE SAME

(71) Applicant: INDUSTRIAL TECHNOLOGY RESEARCH INSTITUTE, Hsinchu (TW)

(72) Inventors: Huai-Kuang FU, Taichung City (TW); Pang-Hung LIU, Hsinchu City (TW); Chia-Wei CHANG, Taichung City (TW); Yuan-Chang HUANG, Hsinchu City (TW); Ya-I HSU, Taoyuan City (TW)

(73) Assignee: INDUSTRIAL TECHNOLOGY RESEARCH INSTITUTE, Hsinchu (TW)

(21) Appl. No.: 14/984,297

(22) Filed: Dec. 30, 2015

(30) Foreign Application Priority Data
Dec. 14, 2015 (TW) 104141877

(51) Int. Cl. B32B 27/20; B32B 15/08; B32B 27/06

(52) U.S. Cl. CPC B32B 27/20; B32B 27/06; B32B 15/08; B32B 2307/306; B32B 2264/00

(57) ABSTRACT

A heat shielding material is provided. The heat shielding material includes a sheet material and a dark pigment layer covering the sheet material. The dark pigment layer includes a crosslinking structure formed of siloxane functional groups and dark pigments dispersing in the crosslinking structure. A heat shielding composition and a heat shielding structure employing the same are also provided.

### CROSS REFERENCE TO RELATED APPLICATIONS

The present application is based on, and claims priority from, Taiwan Application Serial Number 104141877, filed on Dec. 14, 2015, the disclosure of which is hereby incorporated by reference herein in its entirety.

### TECHNICAL FIELD

The disclosure relates to a heat shielding material, a heat shielding composition and a heat shielding structure employing the same.

### BACKGROUND

Global warming causes extreme climate change around the world. Energy conservation and carbon reduction have become the most likely response strategies. So far, heat shielding materials are important green energy products used mainly in building roofs, exterior walls, and windows.

About 40% of sunlight enters indoors from roofs or exterior walls. A white roof is an ideal cool roof, because of its high solar reflectance. However, taking beauty and light pollution into consideration, in reality dark roofs are used more frequently. Because dark roofs rely on foreign imports, they are expensive and offer less choice. In addition, the current dark heat shielding coatings provide insufficient solar reflectance and heat resistance.

Therefore, improved dark heat shielding materials that conform to the demands of good solar reflectance and heat resistance are needed.

### SUMMARY

An embodiment of the disclosure provides a heat shielding material, including a sheet material and a dark pigment layer covering the sheet material. The dark pigment layer includes a crosslinking structure formed of siloxane functional groups and dark pigments dispersing in the crosslinking structure.

Another embodiment of the disclosure provides a heat shielding composition, including 1 part by weight of the aforementioned heat shielding material and 0.1-300 parts by weight of a solvent.

Still another embodiment of the disclosure provides a heat shielding structure, including a substrate and a heat shielding layer disposed on the substrate. The heat shielding layer includes the aforementioned heat shielding material regularly arranged in a resin. The heat shielding material is parallel to each other and substantially parallel to a surface of the substrate. A weight ratio between the heat shielding material and the resin is 0.02-10.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a cross-sectional view of a heat shielding material according to an exemplary embodiment;

FIG. 2 is a schematic view of a heat shielding material during the reaction process according to an exemplary embodiment; and

FIG. 3 is a cross-sectional view of a heat shielding structure according to an exemplary embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

According to embodiments of the present disclosure, the present disclosure provides a heat shielding material, a heat shielding composition and a heat shielding structure employing the same. The heat shielding material of the present disclosure is a sheet material covered by a dark pigment layer. The heat shielding material is capable of improving the total solar reflectance (TSR) and decreasing the L-value of the resulting heat shielding composition and heat shielding structure, which may be widely applied to buildings, walls, roofs, or cars.

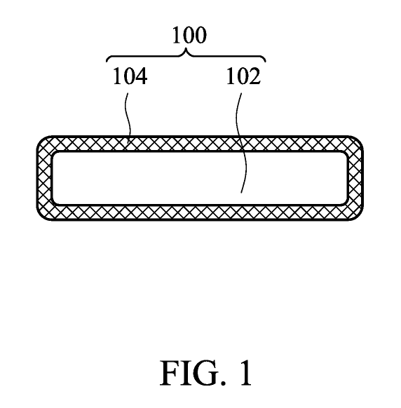

FIG. 1 is a cross-sectional view of a heat shielding material 100 according to an exemplary embodiment of the present disclosure. As shown in FIG. 1, an embodiment of the present disclosure provides a heat shielding material 100, including a sheet material 102 and a dark pigment layer 104. The dark pigment layer 104 covers the sheet material 102. According to some embodiments, the sheet material 102 used in the present disclosure may include mica, synthetic mica, hygrophilite, kaolin clay, montmorillonite, silicon dioxide, sheet metal oxides, slate flake, or a combination thereof. According to some embodiments, the sheet material 102 of the present disclosure may have an average particle size of 0.1-300 μm, for example, 5-80 μm. According to some embodiments, the sheet material 102 used in the present disclosure may have an aspect ratio (a value of length/thickness) of 10-100, for example, 20-80. When the aspect ratio of the sheet material 102 of the present disclosure is too high (i.e. more than 100), the dispersion is poor and the surface of the coating film is rough. In addition, when the aspect ratio of the sheet material 102 of the present disclosure is too low (i.e. less than 10), the shielding ability is poor and the efficacy is insufficient.

In one embodiment of the present disclosure, the dark pigment layer 104 covering the sheet material 102 includes a crosslinking structure formed of siloxane functional groups and dark pigments dispersing in the crosslinking structure. According to some embodiments, the siloxane functional groups used in the present disclosure may have a chemical formula of Si(OR)₄. Each of R may independently be H or alkyl group and the alkyl group may be C₁-C₈ alkyl group, for example.

The aforementioned siloxane functional groups may include tetraethoxysilane (TEOS), methyltriethoxysilane (MTES), n-octyltriethoxysilane, or a combination thereof. After being hydrolysed, the aforementioned siloxane functional groups may have OH groups. According to some embodiments, the dark pigments used in the present disclosure may include Aniline Black, Carbon Black, Shungite, Lamp black, Vine Black, Bone Black, Graphite, Mars Black, Iron Titanium Brown Spinel, Cobalt Black, Manganese Black, Chromium Green Black Hematite, Zinc Sulfide, Mineral Black, Slate Black, Copper Chromite Black, Tin Antimony Gray, Titanium Vanadium Antimony Gray, Cobalt Nickel Gray, Manganese Ferrite Black, Iron Cobalt Chromite Black, Copper Chromite Black, lion Cobalt Black, Chrome Iron Nickel Black, Paliogen Black, Perylene Black, Iron Manganese Oxide, Molybdenum Disulfide, Titanium Dioxide Black, or a combination thereof.

In one embodiment of the present disclosure, the dark pigment layer 104 and the sheet material 102 form a chemical bond such as Si—O—Si bonding through the siloxane functional groups. In addition, an intermolecular force is between the dark pigments 106 and the crosslinking structure, thus the dark pigments 106 attach to and disperse in the crosslinking structure by this intermolecular force. Therefore, through the above chemical bond and intermolecular force, the dark pigment layer 104 formed of the dark pigments 106 and the crosslinking structure may cover the sheet material 102 more completely and stably to assist in improving the TSR % of the resulting heat shielding composition and heat shielding structure.

The heat shielding material 100 provided by the present disclosure may be formed by applying a sol-gel method. For example, the siloxane functional groups, acids, sheet materials, and dark pigments may be mixed first, and then a heating process is applied to the aforementioned mixture to form the previously described heat shielding material 100 of the present disclosure. For the purpose of explanation, specific examples are described below. However, the present disclosure is not intended to be limiting.

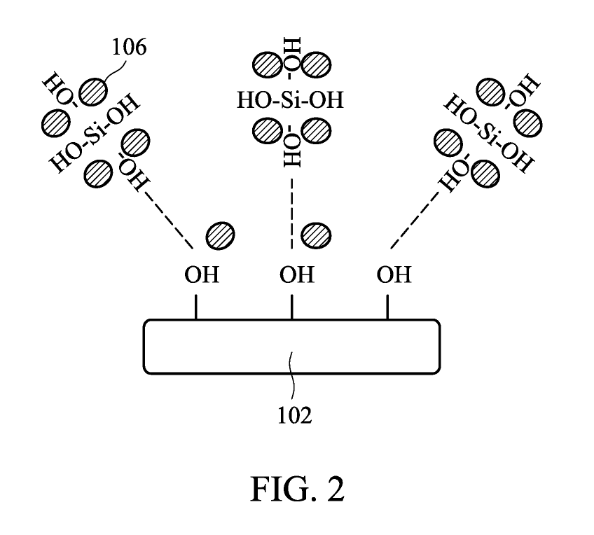

In one embodiment of the present disclosure, tetraethoxysilane (TEOS), an acid, a sheet material 102, and dark pigments 106 are mixed, and then a heating process is applied to the aforementioned mixture to form the heat shielding material 100. In the reaction process, TEOS is reacted with the acid first to hydrolysis the four OR groups connected to Si into four OH groups. At this time, one of the OH groups reacts with an OH group on the surface of the sheet material 102 to form a hydrogen bonding. An intermolecular force is formed between the other three OH groups and the dark pigments 106, so that the dark pigments 106 is attached to the OH groups, as shown in FIG. 2. Next, a heating process is performed. A condensation reaction of the Si—OH of the siloxane functional groups produces Si—O—Si bonding, and thereby forms a crosslinking structure. The dark pigments 106 attached to the OH groups are trapped and dispersed in the crosslinking structure formed of the siloxane functional groups. At this time, the crosslinking structure and the dark pigments 106 dispersed therein together form a dark pigment layer 104. The dark pigment layer 104 covers the sheet material 102. In addition, during the sol-gel reaction, there are also Si—O—Si bonding formed between the surface of the sheet material 102 and the siloxane functional groups. Therefore, through this chemical bond, the dark pigment layer 104 may cover the sheet material 102 more completely and stably to assist in improving the TSR % of the resulting heat shielding composition and heat shielding structure.

In the sol-gel reaction, the siloxane functional groups used in the present disclosure are not limited to tetraethoxysilane (TEOS) and may include other appropriate siloxane functional groups. In one embodiment, the siloxane functional groups may have a chemical formula of Si(OR)₄. Each of R may independently be H or alkyl group.

In one embodiment, the siloxane functional groups used in the present disclosure may be methyltriethoxysilane (MTES), n-octyltriethoxysilane, or a combination thereof. According to some embodiments, the acids used in the sol-gel reaction may include hydrochloric acid, nitric acid, acetic acid, sulfuric acid, or a combination thereof. According to some embodiments, the sheet material 102 may include mica, synthetic mica, hygrophilite, kaolin clay, montmorillonite, silicon dioxide, sheet metal oxides, slate flake, or a combination thereof. However, the sheet material 102 of the present disclosure is not limited thereto. As long as the sheet material has an aspect ratio of 10-100, it may be applied to the present disclosure. According to some embodiments, the dark pigments 106 may include Aniline Black, Carbon Black, Shungite, Lamp black, Vine Black, Bone Black, Graphite, Mars Black, lion Titanium Brown Spinel, Cobalt Black, Manganese Black, Chromium Green Black Hematite, Zinc Sulfide, Mineral Black, Slate Black, Copper Chromite Black, Tin Antimony Gray, Titanium Vanadium Antimony Gray, Cobalt Nickel Gray, Manganese Ferrite Black, Iron Cobalt Chromite Black, Copper Chromite Black, lion Cobalt Black, Chrome lion Nickel Black, Paliogen Black, Perylene Black, Iron Manganese Oxide, Molybdenum Disulfide, Titanium Dioxide Black, or a combination thereof. It should be noted that these examples are merely illustration and the scope of the invention is not limited thereto.

In the present disclosure, the siloxane functional groups and acids are added to the reaction to increase the number of OH groups and make the dark pigments to react with more OH groups. It has been found that it is difficult for hydrolysis to occur when the sheet material, siloxane functional groups, and dark pigments are directly mixed without adding acids, and therefore, the sol-gel reaction would not occur. Although an intermolecular force is formed between the dark pigments and the OH groups on the surface of the sheet material, the number of the dark pigments attached to the surface of the sheet material is not much since a steric hindrance is caused by the siloxane functional groups. On the contrary, hydrolysis becomes faster when the sheet material, siloxane functional groups, and dark pigments are mixed with acids. In such case, the sol-gel reaction occurs. Before the formation of the Si—O—Si bonding, the steric hindrance caused by the hydrolysed siloxane functional groups is small, thus an intermolecular force is easily formed between the dark pigments and the OH groups on the surface of the sheet material. So, the dark pigments are attached to the sheet material. In addition, as described previously, the hydrolysed siloxane functional groups not only forms a hydrogen bond with the OH group on the sheet material, the remaining OH groups of the hydrolysed siloxane functional groups may also have an intermolecular force with the dark pigments to make the dark pigments attach to the sheet material. As such, with the addition of acids, the dark pigments are able to react with more OH groups, and thereby cover the sheet material more completely.

Another embodiment of the present disclosure provides a heat shielding composition. In the present disclosure, the ratio of the between each reactant in the heat shielding composition may be adjusted depending on the desired properties of the heat shielding composition. For example, 1 part by weight of the previously described heat shielding material 100 and 0.1-300 parts by weight of the solvent may be used to form the heat shielding composition. Alternatively, 1 part by weight of the previously described heat shielding material 100 and 1-1000 parts by weight of the solvent may be used to form the heat shielding composition. According to some embodiments, the solvent used in the present disclosure may include methanol, ethanol, isopropanol, n-butanol, methyl ethyl ketone, acetone, cyclohexanone, methyl tertiary-butyl ketone, diethyl ether, ethylene glycol dimethyl ether, glycol ether, ethylene glycol monoethyl ether, tetrahydrofuran (THF), propylene glycol monomethyl ether acetate (PGMEA), ethyl-2-ethoxy ethanol acetate, 3-ethoxy propionate, isoamyl acetate, ethyl acetate, butyl acetate, chloroform, pentane, n-hexane, cyclohexane, heptane, benzene, toluene, xylene, or a combination thereof.

The heat shielding composition may further include a resin. The amount of the resin may be adjusted depending on the desired properties of the heat shielding composition and the thickness of the coating layer formed thereof. For example, the amount of the resin may be 0.1-60 parts by weight or 1-45 parts by weight. The resin used in the present disclosure may include polyester resin, polyimide resin, acrylic resin, epoxy resin, silicone resin, phenoxy resin, urethane resin, urea resins, acrylonitrile butadiene styrene resin (ABS resin), polyvinyl butyral resin (PVB resin), polyether resin, fluorine-containing resin, polycarbonate resin, polystyrene resin, polyamide resin, starch, cellulose, a copolymer thereof, or a mixture thereof. In addition, 0.1-3 parts by weight such as 0.5-2 parts by weight of dispersant may optionally be added into the above heat shielding composition to improve the TSR % of the resulting heat shielding composition. The dispersant may be a polymer type dispersant, for example, ethylene-vinyl acetate copolymer, ethylene-vinyl acetate copolymer mixture, ethylene acrylic acid copolymer, polyamide/oxidized polyethylene copolymer mixture, polyethylene copolymer, or a combination thereof.

It should be noted that the heat shielding material without dispersant already has a superior TSR % than that of the commercial dark heat shielding material. However, the TSR % of the heat shielding composition may further be improved by adding the dispersant. The results may be attributed to that the heat shielding material may easily have a single direction arrangement in the existence of the dispersant.

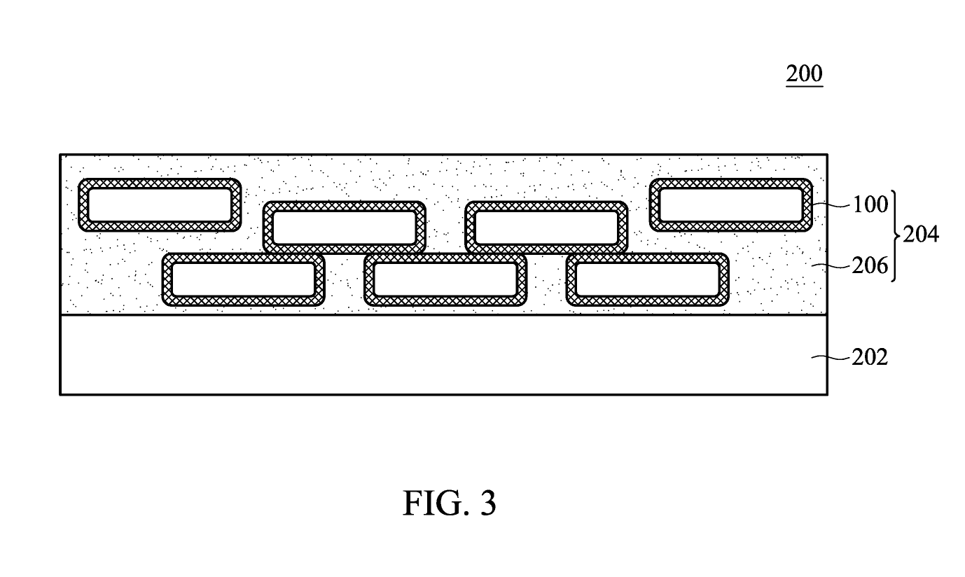

FIG. 3 is a cross-sectional view of a heat shielding structure 200 according to an exemplary embodiment of the present disclosure. As shown in FIG. 3, an embodiment of the present disclosure provides a heat shielding structure 200, including a substrate 202 and a heat shielding layer 204 disposed on the substrate 202. The heat shielding layer 204 includes the previously described heat shielding material 100 regularly arranged in a resin 206. The weight ratio between the heat shielding material 100 and the resin 206 is 0.02-10. The heat shielding material 100 is parallel to each other and substantially parallel to a surface of the substrate 202. It should be noted that the said heat shielding material 100 is substantially parallel to a surface of the substrate 202 may include the condition that an angle between the plane direction of the heat shielding material 100 and the surface of the substrate 202 is no more than 10 degrees.

According to some embodiments, the substrate 202 of the present disclosure may be any solid substrate, for example, rigid substrate, including metal, iron plate, steel plate, galvanized steel, aluminum alloy, magnesium alloy, lithium alloy, semiconductor, glass, ceramics, cement, roof tile, silicon substrate, or for example, flexible substrate, including plastic substrate such as PES (polyethersulfone), PEN (polyethylenenaphthalate), PE (polyethylene), PT (polyimide), PVC (polyvinyl chloride), PET (polyethylene terephthalate), resin, or a combination thereof. The resin 206 used in the present disclosure may include polyester resin, polyimide resin, acrylic resin, epoxy resin, silicone resin, phenoxy resin, urethane resin, urea resins, acrylonitrile butadiene styrene resin (ABS resin), polyvinyl butyral resin (PVB resin), polyether resin, fluorine-containing resin, polycarbonate resin, polystyrene resin, polyamide resin, starch, cellulose, a copolymer thereof, or a mixture thereof.

In the present disclosure, the thickness of the heat shielding layer 204 may be adjusted depending on different applications to obtain a heat shielding structure with the desired properties. For example, the heat shielding layer 204 may have a thickness of 50-1000 nm or 200-600 nm. In addition, a dispersant may optionally be added to the heat shielding layer 204 to improve the TSR % of the resulting heat shielding layer 204. The dispersant may be a polymer type dispersant, for example, ethylene-vinyl acetate copolymer, ethylene-vinyl acetate copolymer mixture, ethylene acrylic acid copolymer, polyamide/oxidized polyethylene copolymer mixture, polyethylene copolymer, or a combination thereof. The weight ratio between the heat shielding material 100 and the dispersant may be 0.3-10, such as 0.5-5.

It should be noted that since the heat shielding material 100 of the present disclosure is a two-dimensional structure, specific coating processes may be used to coat the heat shielding layer 204 onto the substrate 202 to make the heat shielding material 100 be regularly arranged on the substrate 202. For example, the coating processes for regular arrangement may include blade coating, bar coating, wire bar coating, brush coating, roller coating, spray coating, flow coating, other applicable coating processes for regular arrangement, or a combination thereof. In one embodiment of the present disclosure, the L-value of the resulting heat shielding structure 200 may be less than 30, for example, less than 25 or less than 20. In one embodiment of the present disclosure, the TSR % of the resulting heat shielding structure 200 may be more than 20%, for example, more than 30%, more than 35%, more than 40%, or more than 45%.

The heat shielding material provided in the present disclosure is formed by reacting the siloxane functional groups, acids, sheet materials, and dark pigments in a sol-gel reaction by one step. Thus, the process is easier. Steps such as coating the coating material including pigments onto the inner material and a subsequent curing are not required. Also, the resulting heat shielding material formed in the present disclosure makes the dark pigment layer cover the sheet material more completely and stably. In addition, the resulting heat shielding structure has a high TSR % (>20%), a high heat shielding property, and a low L-value (L<30). Therefore, the present disclosure provides a dark heat shielding material with sufficient TSR % and heat shielding property.

Below, examples and comparative examples will be described in detail so as to be easily realized by a person having ordinary knowledge in the art.

### Example 1

1 g of tetraethoxysilane (TEOS), 1 g of Mica M (average particle size: 5.72 μm; aspect ratio), and 1 g of dark pigments (BASF Paliogen 50084) were added into 100 mL of isopropanol (WA) and thoroughly mixed. Then, 0.5 mL, 0.1 N of hydrochloric acid was added into the mixture. Next, a sol-gel reaction was performed for 3 hours at room temperature, then warmed up to 80° C. for additional 3 hours to form a heat shielding material.

### Comparative Example 1

The same process as described in Example 1 was repeated, expect that Mica M was replaced by spherical silicon dioxide (TiO₂) micro particles (average particle size: 0.45 μm).

### Comparative Example 2

Comparative Example 2 was commercial heat shielding nanoparticles (spherical particles, Shepherd 10C909A).

ISO 9050 (Glass in building—Determination of light transmittance, solar direct transmittance, total solar energy transmittance, ultraviolet transmittance and related glazing factors) was used to determine the TSR % of the heat shielding material of Example 1 and Comparative Example 1 and the commercial heat shielding nanoparticle of Comparative Example 2. ASTM D1003 was used to determine the haze of the heat shielding material of Example 1 and Comparative Example 1 and the commercial heat shielding nanoparticles of Comparative Example 2. The L-value was calculated then. L-value is between 1 and 100 and is used to represent the brightness of color. The higher the L-value is, the brighter the color is. The smaller the L-value is, the darker the color is. The determined results of the TSR % and L-value are shown in Table 1.

TABLE 1
Comparison of different heat shielding materials

| | Sheet material | TSR (%) | L-value |
|---|---|---|---|
| Example 1 | Mica M | 47.2 | 24.8 |
| Comparative Example 1 | TiO₂ micro particles | 46.7 | 36.8 |
| Comparative Example 2 | Commercial heat | 21.3 | 25.7 |
| | shielding nanoparticles | | |

As shown in Table 1, when Mica M was used as the sheet material, the resulting heat shielding material had the highest TSR % and the lowest L-value. TiO₂ micro particles and Mica M have similar particle size and color (white). Although the TSR % of the heat shielding materials formed by TiO₂ micro particles and Mica M were close, the L-value of the heat shielding materials formed by Mica M was apparently smaller. Compared to the commercial heat shielding nanoparticle, the TSR % of the heat shielding materials formed by Mica M was apparently larger.

### Example 2

The same process as described in Example 1 was repeated, expect that Mica M was replaced by synthetic mica.

### Example 3

The same process as described in Example 1 was repeated, expect that Mica M was replaced by hygrophilite.

TABLE 2
Comparison of the resulting heat shielding material formed by sheet
material with different aspect ratios

| | | Average | | | |
|---|---|---|---|---|---|
| | | particle | Aspect | | |
| | Sheet material | size (μm) | ratio | TSR (%) | L-value |
| Example 1 | Mica M | 5.72 | 23.83 | 47.2 | 24.8 |
| Example 2 | synthetic mica | 23.0 | 70.55 | 46.5 | 28.9 |
| Example 3 | hygrophilite | 75.6 | 74.12 | 42.8 | 27.2 |

As shown in Table 2, the TSR % of the heat shielding materials formed by the sheet material with aspect ratios of 23.83, 70.55, and 74.12 were all more than 40%, even more than 45%. The L-value of these heat shielding materials were all less than 30, even less than 25.

Below, different siloxane functional groups were used to prepare the heat shielding materials in Example 4 and Example 5. ISO 9050 was used to determine the TSR % of the resulting heat shielding material and ASTM D1003 was used to calculate the L-value of the resulting heat shielding material. The results of comparing Example 1 and Examples 4, 5 are shown in Table 3.

### Example 4

The same process as described in Example 1 was repeated, expect that TEOS was replaced by MTES (Momentive; A162).

### Example 5

The same process as described in Example 1 was repeated, expect that TEOS was replaced by n-octyltriethoxysilane (Momentive; A137).

TABLE 3
Comparison of the resulting heat shielding materials formed by
different siloxane functional groups

| | siloxane functional groups | TSR (%) | L-value |
|---|---|---|---|
| Example 1 | TEOS | 47.2 | 24.8 |
| Example 4 | MTES | 41.1 | 26.3 |
| Example 5 | n-octyltriethoxysilane | 27.2 | 24.8 |

As shown in Table 3, the TSR % of the heat shielding materials formed by different siloxane functional groups were all more than 20%. The TSR % of the heat shielding materials formed by MTES was more than 40%. The L-value of these heat shielding materials formed by different siloxane functional groups were all less than 30, even less than 25.

### Example 6

1 g of the heat shielding material of Example 1 and 5 g of acrylic resin (Eternal Materials Co., Ltd., ETERAC 7132-2-M-20) were thoroughly mixed. The mixture was coated onto a metal substrate by blade coating process, and then dried at 100° C. for 10 min to form a heat shielding structure. ISO 9050 was used to determine the TSR % of the resulting heat shielding structure and ASTM D1003 was used to calculate the L-value of the resulting heat shielding structure.

### Example 7

1 g of the heat shielding material of Example 1 and 1 g of dispersant (DISPARLON, 4200-10) were thoroughly mixed, and then 5 g of acrylic resin (Eternal Materials Co., Ltd., ETERAC 7132-2-M-20) was added and thoroughly mixed. The mixture was coated onto a galvanized steel by blade coating process, and then dried at 100° C. for 10 min to form a heat shielding structure. ISO 9050 was used to determine the TSR % of the resulting heat shielding structure and ASTM D1003 was used to calculate the L-value of the resulting heat shielding structure.

### Comparative Example 3

1 g of commercial Carbon Black (Cabot ML) and 5 g of acrylic resin (Eternal Materials Co., Ltd., ETERAC 7132-2-M-20) were thoroughly mixed. The mixture was coated onto a galvanized steel by a blade coating process, and then dried at 100° C. for 10 min to form a heat shielding structure. ISO 9050 was used to determine the TSR % of the resulting heat shielding structure and ASTM D1003 was used to calculate the L-value of the resulting heat shielding structure.

The results of the determined TSR % and L-value of Example 6, Example 7, and Comparative Example 3 are shown in Table 4. The heat shielding layers of the heat shielding structures of Example 6, Example 7, and Comparative Example 3 have the same thickness.

TABLE 4

| | Heat shielding material | TSR (%) | L-value |
|---|---|---|---|
| Example 6 | Example 1 | 35.1 | 29.3 |
| Example 7 | Example 1 + dispersant | 42.6 | 29.8 |
| Comparative | Commercial Carbon Black | <5 | <10 |
| Example 3 | | | |

As shown in Table 4, no matter the dispersant was added or not, the TSR % of the heat shielding structure formed by the heat shielding material of Example 1 was more than that of the heat shielding structure formed by commercial Carbon Black. The L-values of the heat shielding structures were all less than 30. The difference was that when the heat shielding structure was formed by the heat shielding material of Example 1 without a dispersant, the TSR % was 35.1%, while the heat shielding structure was formed by the heat shielding material of Example 1 with a dispersant, the TSR % was improved to 42.6%. The TSR % of the heat shielding structure was improved about 7.5% compared to that without a dispersant.

An accelerated weathering (QUV) test was used to test the heat shielding structures of Example 6 and Example 7. It was found that the TSR % of the heat shielding structure can be maintained after an QUV irradiation lasting for 1000 hr. According to the standard of ASTM G154, the service life of the above heat shielding structure can be up to 5 years.

The heat shielding material provided by the present disclosure completely and stably covers the sheet material, which is assist in improving the TSR %. In addition, the heat shielding structure formed from this heat shielding material has an improved total solar reflectance (TSR % >45%), a low L-value (L<25), and an improved weather resistance (QUV irradiation lasting for about 1000 hr), which can be widely applied to buildings, walls, roofs, and cars.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A heat shielding material, comprising:
a sheet material; and
a dark pigment layer covering the sheet material, wherein the dark pigment layer comprises:
a crosslinking structure formed of siloxane functional groups; and
dark pigments dispersing in the crosslinking structure.

2. The heat shielding material as claimed in claim 1, wherein the dark pigment layer and the sheet material form a chemical bond through the siloxane functional groups.

3. The heat shielding material as claimed in claim 1, wherein an intermolecular force is between the dark pigments and the crosslinking structure.

4. The heat shielding material as claimed in claim 1, wherein the sheet material has an average particle size of 0.1-300 μm.

5. The heat shielding material as claimed in claim 1, wherein the sheet material has an aspect ratio of 10-100.

6. The heat shielding material as claimed in claim 1, wherein the sheet material comprises mica, synthetic mica, hygrophilite, kaolin clay, montmorillonite, silicon dioxide, or a combination thereof.

7. The heat shielding material as claimed in claim 1, wherein the siloxane functional groups are selected from compounds having a chemical formula of Si(OR)₄, wherein each of R is independently H or alkyl group.

8. The heat shielding material as claimed in claim 7, wherein the siloxane functional groups are selected from tetraethoxysilane (TEOS), methyltriethoxysilane (MTES), n-octyltriethoxysilane, or a combination thereof.

9. The heat shielding material as claimed in claim 1, wherein the dark pigments comprise Aniline Black, Carbon Black, Shungite, Lamp black, Vine Black, Bone Black, Graphite, Mars Black, Iron Titanium Brown Spinel, Cobalt Black, Manganese Black, Chromium Green Black Hematite, Zinc Sulfide, Mineral Black, Slate Black, Copper Chromite Black, Tin Antimony Gray, Titanium Vanadium Antimony Gray, Cobalt Nickel Gray, Manganese Ferrite Black, lion Cobalt Chromite Black, Copper Chromite Black, lion Cobalt Black, Chrome lion Nickel Black, Paliogen Black, Perylene Black, lion Manganese Oxide, Molybdenum Disulfide, Titanium Dioxide Black, or a combination thereof.

10. A heat shielding composition, comprising:
1 part by weight of the heat shielding material as claimed in claim 1; and
0.1-300 parts by weight of a solvent.

11. The heat shielding composition as claimed in claim 10, wherein the solvent comprises methanol, ethanol, isopropanol, n-butanol, methyl ethyl ketone, acetone, cyclohexanone, methyl tertiary-butyl ketone, diethyl ether, ethylene glycol dimethyl ether, glycol ether, ethylene glycol monoethyl ether, tetrahydrofuran (THF), propylene glycol monomethyl ether acetate (PGMEA), ethyl-2-ethoxy ethanol acetate, 3-ethoxy propionate, isoamyl acetate, ethyl acetate, butyl acetate, chloroform, pentane, n-hexane, cyclohexane, heptane, benzene, toluene, xylene, or a combination thereof.

12. The heat shielding composition as claimed in claim 10, further comprising 0.1-60 parts by weight of a resin.

13. The heat shielding composition as claimed in claim 12, wherein the resin comprises polyester resin, polyimide resin, acrylic resin, epoxy resin, silicone resin, phenoxy resin, urethane resin, urea resins, acrylonitrile butadiene styrene resin (ABS resin), polyvinyl butyral resin (PVB resin), polyether resin, fluorine-containing resin, polycarbonate resin, polystyrene resin, polyamide resin, starch, cellulose, or a combination thereof.

14. The heat shielding composition as claimed in claim 10, further comprising 0.1-3 parts by weight of a dispersant.

15. The heat shielding composition as claimed in claim 14, wherein the dispersant comprises a polymer type dispersant, wherein the polymer type dispersant comprises ethylene-vinyl acetate copolymer, ethylene-vinyl acetate copolymer mixture, ethylene acrylic acid copolymer, polyamide/oxidized polyethylene copolymer mixture, polyethylene copolymer, or a combination thereof.

16. A heat shielding structure, comprising:
a substrate; and
a heat shielding layer disposed on the substrate, wherein the heat shielding layer comprises the heat shielding material as claimed in claim 1 regularly arranged in a resin, wherein the heat shielding material is parallel to each other and substantially parallel to a surface of the substrate,
wherein a weight ratio between the heat shielding material and the resin is 0.02-10.

17. The heat shielding structure as claimed in claim 16, wherein the substrate comprises metals and non-metals, wherein the metals comprise stainless steel, carbon steel, galvanized steel, galvanized aluminum board, or a combination thereof, wherein the non-metals comprise cement, calcium silicate board, tile, stone, or a combination thereof.

18. The heat shielding structure as claimed in claim 16, wherein the resin comprises polyester resin, polyimide resin, acrylic resin, epoxy resin, silicone resin, phenoxy resin, urethane resin, urea resins, acrylonitrile butadiene styrene resin (ABS resin), polyvinyl butyral resin (PVB resin), polyether resin, fluorine-containing resin, polycarbonate resin, polystyrene resin, polyamide resin, starch, cellulose, or a combination thereof.

19. The heat shielding structure as claimed in claim 16, further comprising a dispersant, and a weight ratio between the heat shielding material and the dispersant is 0.3-10.

20. The heat shielding structure as claimed in claim 19, wherein the dispersant comprises a polymer type dispersant, wherein the polymer type dispersant comprises ethylene-vinyl acetate copolymer, ethylene-vinyl acetate copolymer mixture, ethylene acrylic acid copolymer, polyamide/oxidized polyethylene copolymer mixture, polyethylene copolymer, or a combination thereof.

21. The heat shielding structure as claimed in claim 16, wherein the heat shielding structure has an L-value <30.

22. The heat shielding structure as claimed in claim 16, wherein the heat shielding structure has a total solar reflectance (TSR) >20%
